(19) United States
(12) Patent Application Publication
(10) Pub. No.: US 2008/0089816 A1
(43) Pub. Date: Apr. 17, 2008

(54) Method For Forming A Packing For Resin Catalytic Packed Beds, And So Formed Packing

(76) Inventors: Dante Siano, Cologno Monzese (IT); Mario Nastasi, Marconia (IT); Elio Santacesaria, Milano (IT); Martino Di Serio, Cava Dei Tirreni (IT); Riccardo Tesser, Caserta (IT); Maurizio Guida, Torre Del Greco (IT)

Correspondence Address: Modiano & Associati, Via Meravigli, 16, Milano, 20123, IT

(21) Appl. No.: 11/665,493

(22) PCT Filed: Oct. 25, 2005
(86) PCT No.: PCT/IB05/03357

§ 371 Date: Apr. 16, 2007

(30) Foreign Application Priority Data
Oct. 28, 2004 (IT) MI2004A002056

(51) Int. Cl. B01J 19/30

(52) U.S. Cl. 422/219

(57) ABSTRACT

A method for forming packing for resin catalytic packed beds, comprising providing elastic elements capable of compressing under the pressure applied by resin particles which expand upon contact with a specific work substance, and have characteristics of elasticity and resiliency which are adapted for the expansion factor of the resin, preparing a packing constituted by a mixture of resin particles and elastic elements, mixed in proportions which are selected as a function of the degree of expansion, and loading the packing so as to constitute an elastic catalytic packed bed which is adapted to remain dimensionally stable following the expansion of the resin particles. The packing thus formed comprises a mixture of particles of resin, which can expand upon contact with a specific work substance and elastic elements.

### TECHNICAL FIELD

The present invention relates to a method for forming a packing to be used for catalytic packed beds formed with catalysts constituted by resins, particularly exchange resins, which expand upon contact with work substances, and to a packing so formed for catalytic packed beds adapted to improve the fluid-dynamics configuration of a reactor.

### BACKGROUND ART

The use of functionalized resins as catalysts is widespread. However, resins are characterized in that they are not dimensionally stable. Resin particles in fact have different degrees of expansion in the presence of specific work substances, such as certain solvents, and the actual size of the particles depends on the type of substance or solvent used and on the degree of cross-linking of the resin.

For this reason, the packing of reactors is often performed by loading a slurry of the already-expanded resin. Otherwise, if expansion is made to occur within the reactor, for example by loading the dry resin and then feeding the liquid phase, there are feeding problems caused by clogging, with the formation of true plugs. This aspect makes it necessary, if one has to regenerate the resin by drying it, in a warm air stream, to unload the reactor and treat the resin in a rotating oven.

Ensuring optimum fluid dynamics within the reactor can be one of the most difficult challenges in the design of the chemical reactor. A fluid-dynamics configuration which is incorrect due to the presence of bypasses or preferential paths can lead to low conversions and less than optimum selectivities, reducing the economic convenience of the process.

Backmixing is another phenomenon which can affect the performance of the reactor both in terms of conversion and in terms of selectivity. In this case, the reactor in fact increasingly differs from the behavior of a plug-flow reactor, which from a theoretical standpoint is the reactor that ensures maximum conversion for an equal retention time.

If resins are used as catalysts in packed reactors, it is possible to work with a procedure which provides for feeding from the top (down-flow) or from the bottom of the reactor (up-flow). In some cases it is preferable to use feeding from the bottom, since top feeding can lead to a breakup of the resin due to the high pressures. In this case, preferential paths are formed which lead to reduced efficiency of the reactor and consequently to reduced conversions and to a partial or more intensive use of the catalyst, with consequent quicker deactivation. Feeding from the bottom (up-flow) avoids the formation of preferential paths, since it allows instead the resin bed to expand by fluidization, but in this case there are considerable backmixing phenomena which reduce the productivity of the reactor.

In order to solve the mentioned problems of resin-packed reactors, it has been proposed to use a reactor with inert rigid packing both for reactors in the up-flow configuration (see U.S. Pat. No. 6,013,845) and in the down-flow configuration (see US 2003/0166976 A1). However, this approach does not solve the problem of the dependency of the size of the resin particles on the degree of cross-linking, and therefore still requires loading the resin in suspension, an operation which moreover requires, in this case, longer time and greater care than in the case of an empty reactor. The settling of the resin bed must in fact be performed slowly, so as to leave no empty spaces in the inert packing bed.

The problem of the expansion of acid resins and of the need to stabilize catalytic beds, with an improvement of the fluid-dynamics configuration of the reactor, is also observed in systems which use the resin in reactive distillation columns. In this case, the resin is confined in variously shaped containers constituted by fine-mesh nets (Katapak® packing, for example), which do not allow the resin to migrate but allow free circulation of fluids. These systems, perfectly suitable as packing for reactive distillation columns, are scarcely efficient for providing packed beds due to the high ratio of empty volume to resin volume. This low efficiency is highlighted in a recent paper (S. Steinigeweg, J. Gmehling, Ind. Eng. Chem. Res. 2003, 42, 3612-3619), in which packings of the Katapak® type are used in the esterification of a fatty acid with methanol.

For example, with a feed of 23 mol/h of acid and 15 mol/h of methanol, with a backflow ratio of 1 in a column having a diameter of 50 mm and a height of 6 m (4 m with Katapak® packing with Amberlyst® resin), operating at atmospheric pressure and at an average temperature of 72° C., an acid conversion of only 40% was obtained.

A technology which is alternative to the proposed ones and would solve the problems observed in the use of chemical reactors packed with catalytic resins is therefore necessary.

### DISCLOSURE OF THE INVENTION

Accordingly, the aim of the present invention is to eliminate the drawbacks noted above in known types of packing in packed reactors by providing a method which allows to provide packings for catalytic packed beds which is capable of eliminating the consequences of the expansion of the resin particles upon contact with the various work substances.

Within this aim, an object of the invention is to provide a packing for catalytic beds which is adapted to ensure optimum fluid dynamics of the bed and allows highly efficient utilization of the system in which it is installed and in particular of the catalytic properties of the bed, even after, or in the presence of, various degrees of expansion of the resin particles being used.

Another object of the invention is to provide a method for forming a packing for catalytic beds with an improved performance which remains constantly optimum in any type of reactor or column in which said packing is used and for any reaction characteristic/characteristics.

Another object of the invention is to provide a method which allows to form a packing for catalytic beds simply and inexpensively and to provide a packing which is adapted for the purpose and can be produced by means of materials which are easily commercially available and can be processed with operations which do not require complicated or expensive technologies.

This aim and these and other objects, which will become better apparent hereinafter, are achieved by a method for forming a packing for resin catalytic packed beds, according to the invention and as defined by the claims, the method comprising the steps of: providing elastic means, which are capable of compressing under the pressure applied by resin particles which expand upon contact with a specific work substance, and have characteristics of elasticity and resiliency which are adapted for the expansion factor of the resin that constitutes the catalytic bed in the presence of the work substance; preparing a packing constituted by a mixture of particles of said resin and of said elastic means, mixed in proportions which are selected as a function of said degree of expansion; and loading said packing so as to constitute an elastic catalytic packed bed which is adapted to remain dimensionally stable following the expansion of the resin particles upon contact with said work substance and allow an easy flow thereof through said catalytic packed bed.

A packing for catalytic packed beds according to the invention comprises particles of resin which can expand upon contact with a specific work substance and elastic means which are adapted to be compressed under the pressure applied by the particles of resin which expand upon contact with said work substance, said resin particles and said elastic means forming a mixture which is constituted by proportions of said particles and elastic means which are selected as a function of the expansion factor of said resin.

A catalytic packed bed is constituted by a packing according to the invention, so that it is elastic and maintains substantially stable dimensions upon contact of the packing with a work substance and upon the expansion of the resin particles correlated to the compression of the elastic means.

### BRIEF DESCRIPTION OF THE DRAWINGS

Further characteristics and advantages of the present invention will become better apparent from the detailed description of a preferred but not exclusive embodiment and of some examples, illustrated by way of non-limiting example in the accompanying drawings, wherein:

FIG. 1 is a side view of a spring which constitutes the elastic means according to the invention, in a non-exclusive embodiment;

FIG. 2 is a plan view of an end opening of the spring of FIG. 1, taken from one end;

FIGS. 3 and 4 are schematic views showing, by way of comparison, the behavior of the particles of a first catalytic resin following contact with a work substance, according to a first example;

FIGS. 5 and 6 are schematic views showing, by way of comparison, the behavior of particles of a second catalytic resin following contact with a work substance, according to a second example;

FIGS. 7 and 8 are schematic views of the behavior of the packing constituted according to the invention, upon contact with a work substance;

FIG. 9 is a schematic view of the size variation of particles of two different resins following their contact with work substances; and

FIG. 10 is a diagram of a system with a reactor with catalytic packed bed provided with the packing according to the invention.

### WAYS OF CARRYING OUT THE INVENTION

With reference to the accompanying figures, in a preferred but not exclusive embodiment of the invention, a packing 5 for catalytic packed beds 12 is provided which comprises resin particles 11 which can expand upon contact with a specific work substance and elastic means 1 which are adapted to be compressed under the pressure applied by the resin particles 11 which expand upon contact with the work substance.

The resin particles 11 and the elastic means 1 form a mixture 5, which is constituted by proportions of particles 11 and elastic means 1 which are selected according to the expansion factor of the resin.

Preferably, the mixture 5 is a uniform mixture.

A packing is thus constituted in which, together with the resin particles 11, there are elastic means 1 which are manufactured and selected so as to have a shape and size which allow them to cushion or compensate substantially completely the expansion of the resin particles 11 that occurs as a consequence of contact with the work substance. The compensation is due mainly to the compression of the elastic means within limits which ensure interparticle spaces that allow the constituted packing to provide no hindrance to the circulation of the fluid in the reactor or column or other device in which it is arranged. The elastic means 1 are made of a material which is chemically compatible with the work substance, i.e., capable of keeping unchanged its physical and chemical characteristics in contact therewith. In particular, materials which are inert with respect to the work substances can be selected.

Such work substances can be constituted by a single chemical substance or by a plurality of chemical substances combined in various proportions adapted to form the reaction substance.

In a preferred but not exclusive embodiment, the elastic means are constituted by elastic springs, particularly helical springs 1, which are made of wire coiled in a spiral, as shown in the figures, in which the turns 3 have a plan shape which may be of any kind, so long as it can form the turns 3 that constitute the spring 1. For example, round, polygonal, square, rectangular, elliptical or triangular shapes are adapted.

Once the turns 3 have been formed, they extend so as to form a spring body 1, with a spatial shape which is adapted to compress easily as a consequence of the expansion of the resin particles 11, yet maintaining distances between the expanded particles which allow easy and uniform flow of work substance among the particles 11.

Spatial shapes suitable for this purpose are, for example, a prism, cylinder, cone, pyramid, frustum, truncated pyramid, sphere, ellipsoid, paraboloid or ovoid.

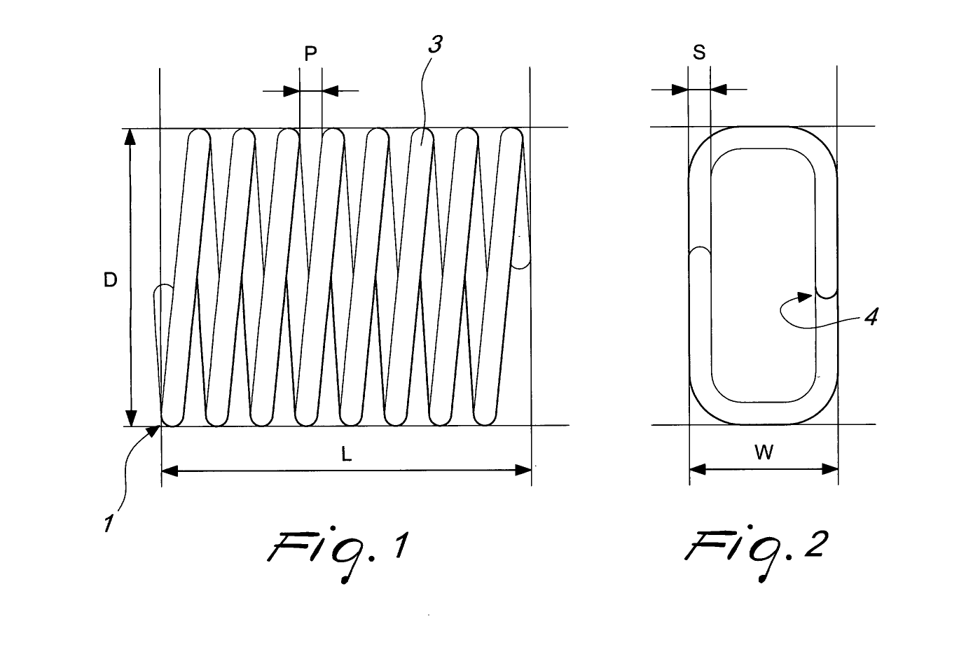

The springs 1 are constituted preferably by wire whose cross-section and length are selected so that it can be coiled or shaped into turns 3 with preset cross-sectional dimensions D, W and pitch P (see FIGS. 1 and 2) so as to provide the spring with an elasticity and resiliency which are adapted to make it compressible so as to compensate for the expansion of the resin particles 11 and to provide end openings 4 which are shaped appropriately in order to prevent said particles from accessing the inside of the spring 1 or jamming between its turns 3, even when they are in a non-expanded state. In particular, the end openings 4 can be provided with passage dimensions which are slightly smaller than the average size of the catalytic particles 11 selected to provide the packing.

Moreover, the materials of which the elastic means, particularly the springs 1, are made are selected among the ones which have an elastic behavior adapted for compression to compensate for the expansion of the resin particles 11 in the manner described above. Examples of these materials comprise metals and/or alloys thereof, ceramics, glass, or plastic materials treated and worked so as to constitute the intended elastic structure.

By using the described packing according to the invention, an elastic catalytic packed bed 12 is obtained which is adapted to maintain substantially stable dimensions even following contact of the resin particles 11 with the work substance and following the expansion of said particles. Said expansion is in fact conveniently compensated by the corresponding compression of the elastic means 1, which however leave a degree of void which is sufficient to ensure a stable fluid-dynamics configuration, with minimal load losses for easy and uniform flow of the work substance through the bed 12. The particles are also thus forced to assume a fixed position, ensuring constant and highly efficient development of processes.

Indeed, with a suitable calibration of the characteristics of the elastic means and of the proportions of the mixture 5, which can be achieved precisely in the conditions according to the invention, the resulting variation of the volume of the bed 12 following contact with the work substance tends to zero, i.e., is substantially nil, and is in any case such as to allow the easy and uniform flow of work substance through the interparticle spaces formed by the elastic means 1, even in the compressed state, mixed among said particles.

The method according to the invention for providing the described packing for resin catalytic packed beds 12 comprises providing elastic means 1 which are capable of compressing under the pressure applied by resin particles 11 which expand upon contact with the specific work substance and have characteristics of elasticity and resiliency which are adapted to the expansion factor of the resin that constitutes the catalytic bed 12 in the presence of said work substance, the preparation of the packing constituted by the mixture 5 of resin particles 11 and of the elastic means 11 mixed in proportions which are selected as a function of said factor of expansion, and the loading of the packing so as to constitute the elastic catalytic packed bed 12, which is adapted to remain dimensionally stable following the expansion of the particles 11 upon contact with the work substance and allow an easy flow thereof through the catalytic bed 12.

Prior to the step for providing elastic means, the method might comprise preliminary steps for determining the expansion factor of the resin particles in contact with the specific work substance, both by performing tests and on the basis of information and data known in the art, and in order to establish the average size of said resin particles 11.

It is possible to prepare match-up tables with correlated information and data which relates to suitable pairings of springs/particulate resins/specific work substances, for reactors or columns, so as to type the work for constituting the catalytic bed.

Some practical experiments have been performed and are described in the examples that follow, which use a packing constituted by a spring 1 made of an Inconel® alloy of Ni(50%)/Cr(15%) Fe(20%). The elastic means, particularly the spring 1, had a cross-section (shape of the turn 3) which was substantially rectangular, with a long side D and a short side W of the coiling rectangle of 2.2 mm and 1.0 mm respectively: the length of the spring L in the uncompressed state was 2.6 mm and the wire that formed the turns 3 had a thickness/diameter of 0.2 mm.

It was verified that the resin particles 11 could not penetrate the spring 1 but could only compress it, deforming it as required.

The proportions of resin/springs for forming the mixture 5, in order to obtain dimensionally stable catalytic beds, were determined by knowing the expansion characteristics of the resin. Said resin was loaded dry, mixing it uniformly with the springs 1 in proportions studied so as to be able to cushion substantially completely, due to the elastic compression of the springs, the expansion effect that occurs following the feeding of a solvent, such as for example water or methanol.

The examples of use of springs as packing refer to the reaction for esterification of the fatty acids contained in vegetable oils with methanol.

These examples should be considered merely demonstrations of what has been described and do not limit the generality of the invention.

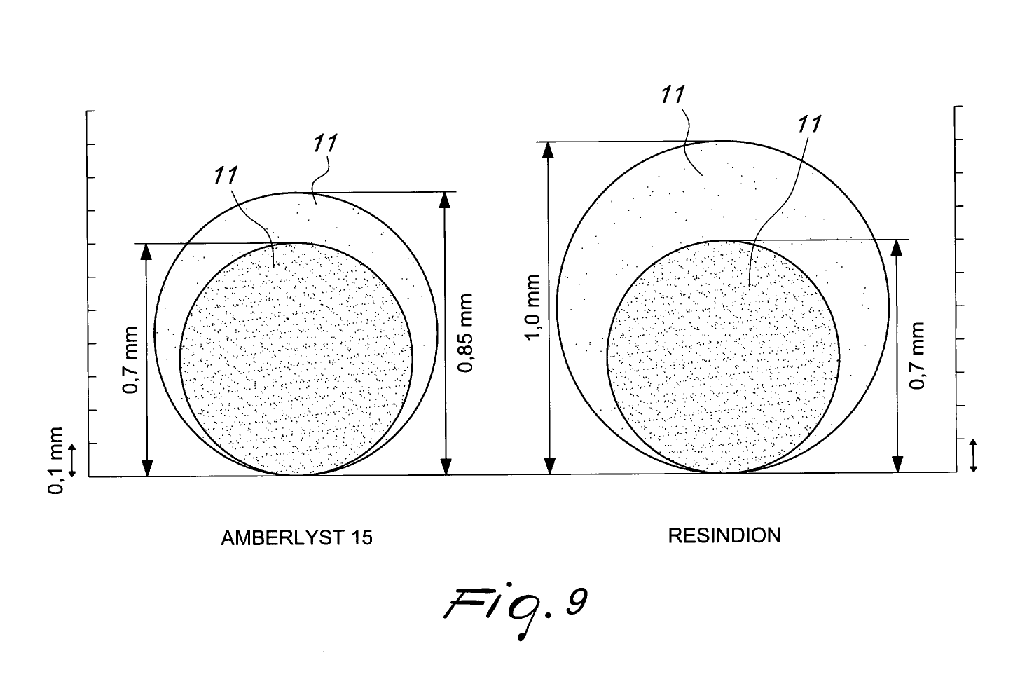

The resins used in the examples (see FIG. 9) are Amberlyst® 15 and Resindion CFS/MB. The former, by contact with methanol, in a packed bed, produces an expansion effect which determines an increase of the poured volume, due to expansion, by a factor of approximately 1.6, whereas for the Resindion CFS/MB resin this factor is approximately 2.4.

The average size of the dry particles, i.e., the distance between two extreme opposite points of the particle, was 0.7 mm in both cases.

It was found that the addition of springs 1, similar to the ones shown in FIGS. 1 and 2, in adequate proportions reduces substantially and practically eliminates the effects of the expansion of the resin, as can be observed in the examples that follow.

### EXAMPLE 1

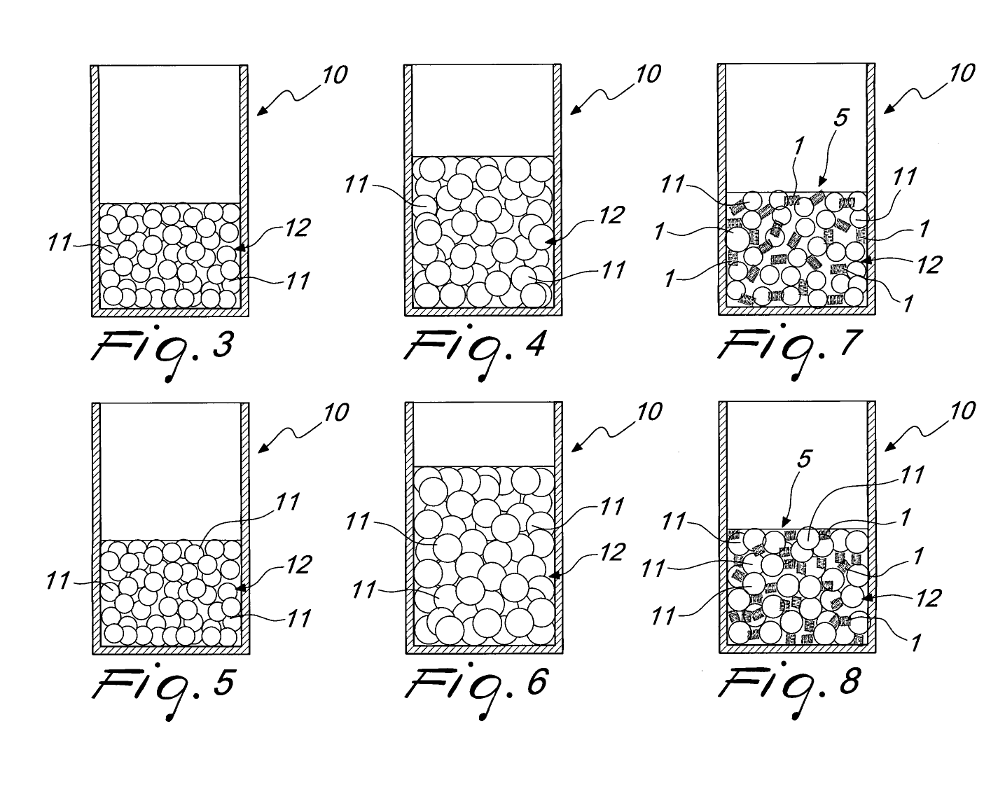

6.3 g of dry Amberlyst® 15 resin were loaded into a graduated glass cylinder 10 (FIG. 3). The average size of the particles 11, which were substantially spherical, was 0.7 mm. The catalytic bed 12 with dry resin had a volume of 11 cm³. The resin was then made to expand by contact with methanol. The catalytic bed 12 (FIG. 4), after expansion, reached a volume of 17 cm³, which is equivalent to an expansion factor of 1.54, in accordance with the literature data (T. Pöpken et al.; Ind. Eng. Chem. Res. 2000, 39 (7), 2607), which is equal to 1.55.

### EXAMPLE 2

4.07 g of dry Resindion CFS/MB resin were loaded into a graduated glass cylinder 10 (FIG. 5). The average size of the particles 11, which were substantially spherical, was 0.7 mm. The catalytic bed 12 with dry resin had a volume of 5 cm³. The resin was then made to expand by contact with methanol. The catalytic bed 12 (FIG. 6), after expansion, reached a volume of 12 cm³, which is equivalent to an expansion factor of 2.4.

### EXAMPLE 3

A mixture 5 of dry Resindion CFS/MB exchange resin, which has the highest expansion factor, was placed in the same graduated cylinder 10 (FIG. 7) used in Examples 1 and 2 with the springs 1 of the type shown in FIG. 1.

5 g of resin received the addition of 9 g of springs 1, filling a volume of 12.6 cm³. By contact with methanol, the bed 12 expands (FIG. 8) by approximately 5%, i.e., equal to a final volume of 13.1 cm³.

### EXAMPLE 4

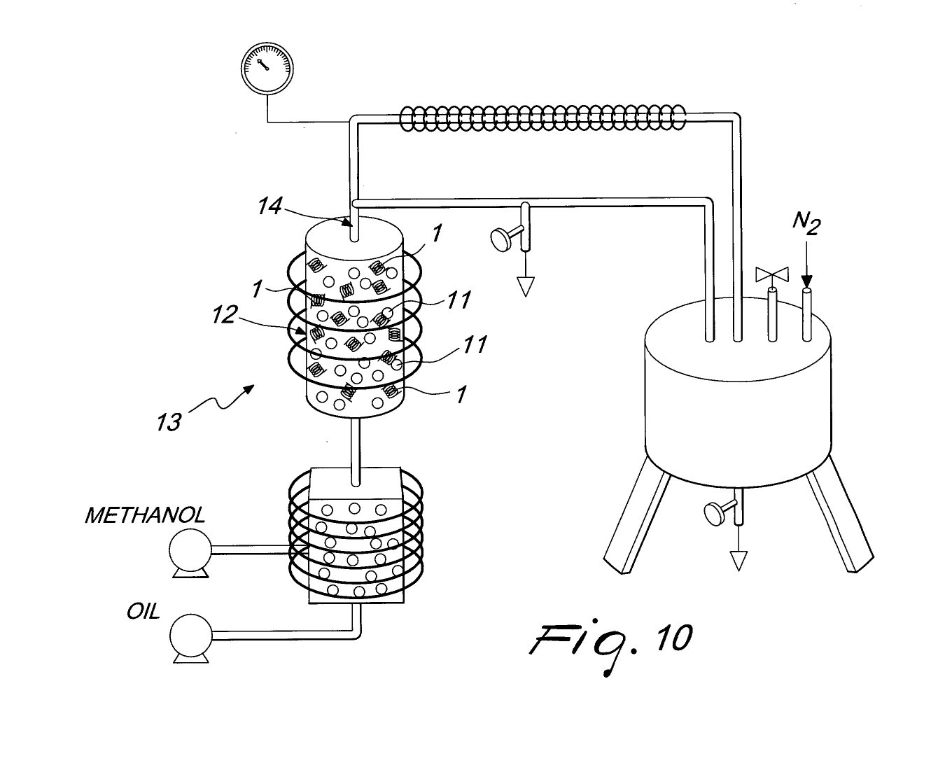

5 g of dry Resindion CFS/MB resin were loaded into a tubular reactor 13 (of the type shown in FIG. 10) with an inside diameter of 1 cm. A flow-rate constituted by 1.0 cm³/min of methanol and 1.7 cm³/min and a mixture constituted by soybean oil and oleic acid (50% by weight) was fed. The temperature of the reactor was 90° C. The outlet 14 of the reactor was buffered with nitrogen at a pressure higher than the vapor pressure of the methanol (5-10 atm). After a few minutes of operation, it was necessary to stop the feeding due to the excessive load losses recorded.

### EXAMPLE 5

5 g of dry Resindion CFS/MB resin and 9 g of springs 1 of the type shown in FIG. 1 were loaded into the same reactor 13 of Example 4 (FIG. 10). A flow-rate constituted by 1.0 cm³/min of methanol and 1.7 cm³/min of a mixture constituted by soybean oil and oleic acid (50% by weight) was fed. The temperature of the reactor was 90° C. The outlet 14 of the reactor 13 was buffered with nitrogen at a pressure higher than the vapor pressure of methanol (5-10 atm). Feeding was performed for more than 100 hours of operation without having clogging problems, with a conversion of the oleic acid to ester of 40-50%.

In practice it has been found that the packing method and the packing itself according to the invention precisely achieve the intended aim, since they allow to have an elastic catalytic packed bed which can be constituted easily so that it maintains stable dimensions through the reaction processes.

The method and packing thus conceived are susceptible of modifications and variations, which are evident to the person skilled in the art and are all within the scope of the accompanying claims.

All the details, such as the material and the configuration of the springs, may further be replaced with other technically equivalent ones and depending on the state of the art, selected for example, but not only, depending on the type and shape of the particles of resin and on other factors or elements involved in the process.

All these variations, which are obvious to the person skilled in the art, are understood to be within the protective scope of the appended claims.

The disclosures in Italian Patent Application No. MI2004A002056, from which this application claims priority, are incorporated herein by reference.

What is claimed is:

1-19. (canceled)

20. A method for forming a packing for resin catalytic packed beds, comprising the steps of:
providing elastic means, which are capable of compressing under pressure applied by particles of a resin for forming a catalytic bed and which expand, according to an expansion factor, upon contact with a specific work substance, the elastic means having characteristics of elasticity and resiliency which are adapted to the expansion factor of the resin that constitutes the particle catalytic bed in the presence of the work substance;
preparing a packing constituted by a mixture of particles of said resin and of said elastic means, mixed in proportions which are selected as a function of said expansion factor; and
loading said packing so as to constitute an elastic catalytic packed bed which is adapted to remain dimensionally stable following the expansion of the resin particles upon contact with said work substance and allow an easy flow thereof through said catalytic packed bed.

21. The method of claim 20, wherein said elastic means are made of a material which is chemically compatible, and inert, with respect to the work substance, said work substance being constituted by a single chemical substance or by a mixture of chemical substances.

22. The method of claim 20, wherein said mixture of resin particles and elastic means is prepared by mixing, in proportions which are selected so as to be compatible with the expansion factor of the resin of the resin particles and elastic means so as to obtain a uniform mixture.

23. The method of claim 21, wherein said elastic means are formed in the shape of elastic springs.

24. The method of claim 23, wherein said elastic springs are shaped like helical springs constituted by a wire coiled in a spiral, wherein a shape of the turns is selected among round, polygonal, square, rectangular, elliptical, triangular or other shape which can form coils which constitute a spring.

25. The method of claim 24, wherein said elastic springs are formed with turns which have a spatial extension which constitutes bodies whose shape can be selected among prism, cylinder, cone, pyramid, frustum, truncated pyramid, sphere, ellipsoid, paraboloid, ovoid or other shape adapted to allow compression of the spring under said pressure generated by the expansion of the resin particles.

26. The method of claim 22, comprising, prior to said step for providing elastic means, a step for determining the expansion factor of the resin particles in contact with said specific work substance, by performing tests or on the basis of information and data known in the art, and a step for determining the average size of said resin particles.

27. The method of claim 24, wherein said elastic springs are made of wire having selected dimensions in cross-section and length and a pitch and end openings selected so as to ensure that the spring has said characteristics of elasticity and resiliency which are adapted to prevent dry resin particles from accessing an inside region of the spring or lodging between the turns of said springs.

28. The method of claim 24, wherein said elastic means are made of materials selected among a group comprising metals and/or alloys thereof, ceramics, glass, plastic materials, or other materials which are chemically compatible with the work substance and can have an elastic behavior adapted for constituting said elastic means.

29. A packing for catalytic packed beds, comprising particles of a resin which can expand upon contact with a specific work substance and elastic means which are adapted to compress under a pressure applied by the resin particles which expand upon contact with said work substance, and wherein said resin particles and said elastic means form a mixture constituted by proportions of said particles and elastic means which are selected as a function of the expansion factor of said resin.

30. The packing of claim 29, wherein said elastic means are made of a material which is chemically compatible, and inert, with respect to the work substances, said work substances being constituted by a single chemical substance or by a mixture of chemical substances.

31. The packing of claim 29, wherein said mixture is a uniform mixture.

32. The packing of claim 30, wherein said elastic means are constituted by elastic springs.

33. The packing of claim 32, wherein said elastic springs are helical springs constituted by a wire which is coiled in a spiral, with turns having a plan shape which can be selected among round, polygonal, square, rectangular, elliptical, triangular or other shape which can form the turns which constitute said springs.

34. The packing of claim 33, wherein said turns constitute a body which has a spatial shape of a prism, cylinder, cone, pyramid, frustum, truncated pyramid, sphere, ellipsoid, paraboloid, ovoid or another shape which is adapted to compress elastically under the pressure generated by the expansion of said resin particles.

35. The packing of claim 33, wherein said springs are made of wire which has a cross-section, length, pitch and end openings which are adapted to ensure that the springs have an elasticity and resiliency which are adapted to the expansion factor of the resin particles and adapted to prevent said particles from accessing an inside region of the springs or lodging between the turns thereof.

36. The packing of claim 30, wherein said elastic means are made of materials selected from the group which comprises metals and/or alloys thereof, ceramics, glass, plastic materials, or other materials which are chemically compatible, and in particular inert, with respect to the work substances and capable of having an elastic behavior which is adapted to constitute said elastic means.

37. A catalytic packed bed constituted by a packing as set forth in claim 29, so as to be elastic, maintain dimensions which are substantially stable following contact of the packing with a work substance and the expansion of the resin particles which is correlated to the compression of the elastic means and a fluid-dynamics configuration which is suitable to allow easy and uniform flow of said work substance therethrough.

38. The catalytic packed bed of claim 37, wherein a variation of its volume following contact with the work substance is substantially nil and such as to allow said easy and uniform flow of the work substance through interparticle spaces provided by said elastic means, even in a compressed state thereof, when mixed among said particles.
